(19) United States
(12) Patent Application Publication
(10) Pub. No.: US 2008/0162568 A1
(43) Pub. Date: Jul. 3, 2008

(54) SYSTEM AND METHOD FOR ESTIMATING REAL LIFE RELATIONSHIPS AND POPULARITIES AMONG PEOPLE BASED ON LARGE QUANTITIES OF PERSONAL VISUAL DATA

(76) Inventor: Huazhang Shen, Arcadia, CA (US)

Correspondence Address: YING CHEN;Chen Yoshimura LLP, 255 S. GRAND AVE., # 215, LOS ANGELES, CA, 90012, US

(21) Appl. No.: 11/872,975

(22) Filed: Oct. 16, 2007

Related U.S. Application Data
(60) Provisional application No. 60/852,267, filed on Oct. 18, 2006.

(51) Int. Cl. G06F 17/30

(52) U.S. Cl. 707/104.1; 707/E17.019

(57) ABSTRACT

A system and method is described to estimate real life relationships between people based on large amount of personal visual information, e.g., photos and videos. Such information is associated with annotation especially face information. The system contains a large database of visual images extracted from common media formats such as photos and videos contributed by many different users. People appear in these images are annotated with metadata such as name of face owners, location of faces, size of faces, as well as any additional features extracted on the faces and the images themselves. The images are also annotated with metadata such as time, location, event, keyword, etc. The system includes an algorithm to estimate relationships between people appear in these images based on the image data and metadata for each image in the database. The system also includes an algorithm to estimate popularity of people appear in these images based on the same information.

This application claims priority from U.S. Provisional Patent Application No. 60/852267 , filed Oct. 18, 2006, which is herein incorporated by reference in its entirety.

### BACKGROUND OF THE INVENTION

### Field Of The Invention

This invention relates generally to techniques for analyzing information in large amount of images extracted from common personal visual information such as photos and videos. More particularly, it relates to methods for identifying user relationship and popularity information, including assigning ranks to relationships between an user and all his/her contacts, or ranks of popularity for each person within a specified group of people.

### SUMMARY OF THE INVENTION

The system and method in the present invention quantify the real life relationship among people. Relationship here refers to a multi-dimensional, dynamic data structure that describes the strength of connection between two people in different contexts (FIG. 1). Relationship is multi-dimensional, for example, two people might be very close to each other with regard to gourmet food, but not very close with regard to fashion. Relationship is dynamic, for example, two people might be very good friends at a certain time in the past but not anymore. Relationship may be location dependent, for example, two people might be close with regard to “Los Angeles”, but not very close with regard to “Miami”. Relationship could be uni-directional or bi-directional, for example, A and B could both consider the other party as friend, or A considers B as friend, but B doesn't consider A as friend.

There are great needs to obtain relationships information between people automatically. With the fast growth of internet (there are about 1 billion internet users around the world), internet users are not only interacting with a large and growing number of people online, but also facing huge amount of information online, needless to say that a lot of them are either irrelevant or unwelcome. With quantified relationship information between any two internet users, content can be delivered based on such relationship information. Content delivery via such a trusted source (or reference) will therefore be very targeted and effective.

Relationships specified by the users themselves will be the most accurate, however, this is too tedious a task for most people, considering that most people have dozens, even hundreds or more contacts whom they interact with. Alternative approaches to automatically obtain relationships among people may be achieved using text based methods. Relationship information among people can be computed by analyzing user profile information, contacts information, and user behavior information on social community websites, or by scanning one's email communication, blogs, instant messenger records, etc. One issue facing these text based approach is to link different identities in these textual contents to different contacts in real life, since most likely one may use multiple “internet” identities to interact with other people (e.g. multiple email addresses, different instant messenger IDs, different online IDs, etc.). Therefore, these methods are not sufficient to obtain the accurate and useful relationship information. Meanwhile, if properly applied, these approaches can potentially deliver accurate relationship information, and may be used in conjunction with the image based approach described in this patent to further refine the results.

There are also needs to estimate popularity of certain people in a small group of people or in a large group of people. Popularity is also a dynamic parameter that depends on the people, time, location, and topic. Popularity index can be used to present contents related to the “popular” people to a general audience, such as presenting celebrity information to their fans. The popularity of a person can be viewed as the accumulation of relationship from “fans” to this person. Sometimes popularity is preferred over relationship in real applications for simplicity, especially when they can provide similar results mathematically.

The system and method in the present invention provide a solution to identify real-life relationships among people based on their appearance in large amount of real life photos and other digital media (visual information). Systems with intelligent and targeted content delivery can be designed based on the relationship information. It allows a user to effortlessly manage large amount of personal contacts, as well as large amount of digital (or digitalized) contents shared among these contacts. It also provides the possibility to adequately address privacy issues using a relationship-based access control system. The system and method in the present invention also provide a solution to identify popularity index of people based on their appearance in large amount of real life photos or other digital media (visual information). Such popularity information can be used to deliver contents related to “popular” people to their “fans”—people who are interested to know their updates.

### BRIEF DESCRIPTION OF THE DRAWINGS

FIG. 1 schematically illustrates a model for quantification of real life relationships among people.

FIG. 2 schematically illustrates an example of relationships using a simple 4-people, 4-photo model.

FIG. 3 schematically illustrates effects from number of photos in which two people show up together.

FIG. 4 schematically illustrates effects from positions, sizes, and their relative positions of faces on photos. Shown on left, four faces of the same size but different distances between A and B, C, D. Shown on right, same distances between A and B, C, D but B, C, D has different sized faces.

FIG. 5 schematically illustrates effects from number of photos and time information for events.

FIG. 6 schematically illustrates effects from time of events on computing time-dependent relationships.

FIG. 7 schematically illustrates effects from time of events on computing time-dependent relationships.

FIG. 8 schematically illustrates effects from keyword correlation on computing keyword-dependent relationships.

FIG. 9 schematically illustrates an example of popularities using a simple 4-people, 4-photo model.

FIG. 10 schematically illustrates effects from number of photos people appear in on computing popularity.

FIG. 11 schematically illustrates effects from number of photos in events on computing popularity.

FIG. 12 schematically illustrates effects from event time information on computing time-dependent popularity.

FIG. 13 schematically illustrates effects from event time information on computing time-dependent popularity.

FIG. 14 schematically illustrates effects from keyword correlation on computing keyword-dependent popularity.

FIG. 15 is a block diagram illustrating a system according to embodiments of the present invention.

### DETAILED DESCRIPTION OF THE PREFERRED EMBODIMENTS

### System Overview

The system and method according to embodiments of the present invention provide an approach to quantify relationship among people based on large amount of personal visual data such as photos and videos. They also provide an approach to quantify popularity of people based on such information. Further, they provide an approach to deliver contents based on the quantified relationship information and popularity information. Finally, they provide a management system to access such relationship and popularity information.

In general, the system and method according to the present invention is applicable to any type of personal visual information that contains people's appearances, such as photos and videos. For convenience of discussion, we limit the data source to photos in the rest of this writing, but those skilled in the art will recognize the fact that the methodology that applies to photos is directly applicable to image data extract from other visual sources such as videos. Each piece of video can be treated as a series of photos that are consecutive in time, close in location, and associated with the same set of keywords. These photos are also annotated with audio information (comes with the video) at specific time stamps, which may be converted into text to provide additional information.

The description below uses photos as an example of personal visual information. A system according to embodiments of the present invention typically includes a large database to store information related to each user and photos with metadata such as who are in these photos, where they are, etc., an algorithm to compute relationship based on information in this database, and an application engine to use the relationship information to achieve targeted content delivery as well as content management. The system that input data to this database (such as a photo sharing system with ability to collect textual user information and user input as well, shown in FIG. 15 as components 1504 and 1508) is not described in this patent. Some of these components may not be necessary in all embodiments of the invention.

### System Operation

Referring to FIG. 15, the primary components of the system and method according to embodiments of the present invention include: 1) a database 1510 storing large amounts of photos and associated metadata. The metadata includes people's faces appear in these photos, positions and sizes of these faces, other information related to the photos, including information related to owners of the photos, content of the photos, any annotation on the photos, etc; 2) an algorithm 1512 that computes relationships between any specific user and his/her contacts who appear in photos that contain this user; 3) an algorithm 1514 that computes relative popularities of certain people among multiple other people; 4) a system 1520 and 1524 to manage and retrieve the relationship/popularity information (stored in data bases 1516 and 1518) and personal visual data (stored in the database 1510) that relate to or manifest such information; 5) use of the quantified relationship information or popularity information to realize target content delivery in various applications (components 1522, 1526, 1528, 1530, 1532 and 1534). These components will be described in more detail in the following paragraphs.

### 1) Photo Annotation

The system and method according to embodiments of the present invention use a large database 1510 to store large numbers of photos and associated metadata. Many types of metadata are possible. The metadata could be collected via automatic approaches (block 1506 in FIG. 15), for example, metadata extracted from the EXIF data, or information extracted using image processing technology. The metadata could also be collected via manual approaches (block 1508 in FIG. 15), for example, keywords applied, rating added, faces labeled, object labeled, comments added by the users. A partial list of metadata utilized by the system and method according to the present invention are: 1) the date and time the photo was taken; 2) the location where the picture was taken; 3) people present in the photo and their location in the photo; 4) associated event information; 5) privacy settings associated with the photo; 6) the author of the photo; 7) modification history; 8) user rating; 9) usage statistics (e.g., how often and when a photo was viewed; how often a photo was commented, how relevant a photo was found to be in search results); 10) any and all user annotations; 11) the owner of the metadata.

### 2) Algorithm to Compute Relationship

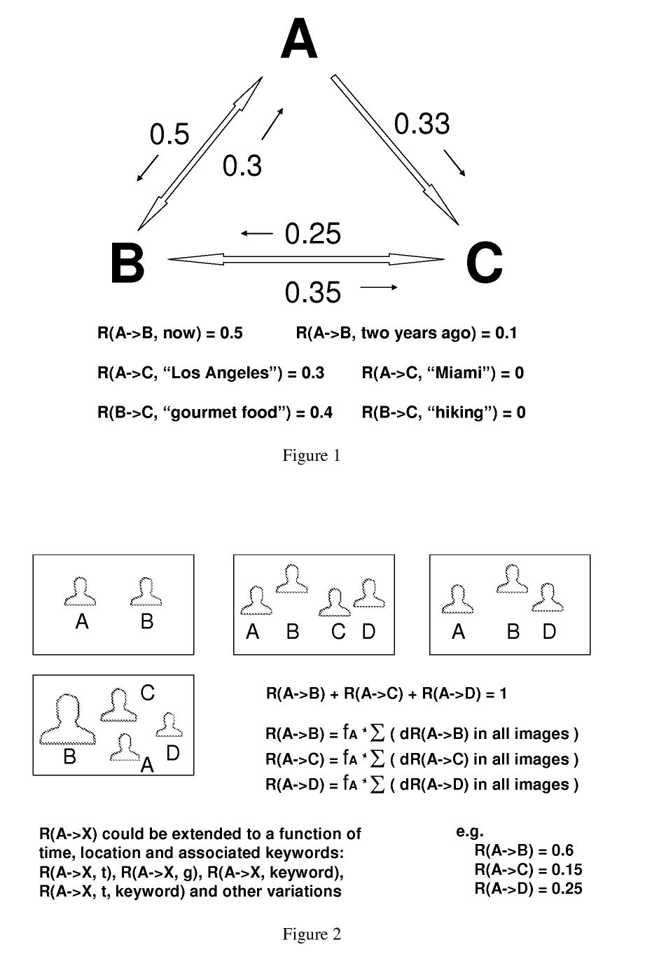

Referring to FIG. 1, we use the notation R(A->B) to represent relationship from A to B, which has a non-negative real number as its value. Because R(A->B) is also a function of parameters such as time, location and keywords, we also use variations for R(A->B) such as R(A->B, t) where t is the time, R(A->B, g) where g is the geographical information, R(A->B, keyword) where keyword is the keyword object, which could include one or more keywords, or R(A->B, t, keyword), which is the variation when both time and keywords are considered, or other variations such as R(A->B, g, keyword), R(A->B, t, g), R(A->B, t, g, keyword) with similar definitions. We also use the notation dR(A->B)[photo] to represent the incremental (delta) contribution towards R(A->B) from a specific photo. This notation also applies to variations of dR(A->B)[photo] similarly. FIG. 1 gives some examples of such relationships.

As shown in FIG. 2, when the system analyzes relationship between A and his/her contacts (in this example only B, C, D for simplicity), all photos that include user A are identified from the system (in this example only 4 photos are identified for simplicity).

Relationships between specific user A and his/her contacts are relative values. For simplicity, they are normalized so that R values between A and all his/her contacts add up to unity. A normalization factor (f_{A} as shown in FIG. 2) is needed. As shown in FIG. 2, the following R values are presumably computed from information in these four photos: R(A->B)=0.6; R(A->C)=0.15; R(A->D)=0.25. In a simple situation like this, it is obvious to reach similar conclusion by noticing that B shows up in all 4 photos with A, while C in 2, and D in 3. To compute R values in real implementation of the system, multiple additional factors need to be considered (they are described in details below).

One way to estimate R(A->B) is by using the following formula:

R(A->B)=Σ(f_{A1}*m₁*c₁+f_{A2}*m₂*c₂+ . . . +f_{An}*mₙ*cₙ)/N (1)

In formula (1), Σ is used to represent that contributions from all photos are added together to get the final R value. c₁, c₂, . . . , cₙ are contributions from n different resources (each resource correspond to a property, such as relative size of the person's face in a photo) for each single photo, m₁, m₂, . . . , mₙ are modulation factors for the n different resources for each single photo, f_{A1}, f_{A2}, . . . , f_{An} are coefficients (which are constants) for each contribution. Contribution from each resource could be the plain numerical value of this resource (or property). However, most likely it will take the form of some mathematical derivation from such values (such values are usually put in logarithmic scale, but other variations or more complicated form are also possible). Contributions from some resources may also take the form of modulation factors to adjust the contributions from other factors. N is the normalization factor, which correlates to the number of photos these two people both appear in, as well as possibly other factors.

In formula (1), simple addition is used to combine contributions from different resources and different photos. However, other forms of combination may also be possible.

The basic assumption to use this formula is that contributions from different resources (c₁, c₂, . . . , cₙ) are orthogonal, in other words, there is no correlation between these factors. However, this is usually not the case in reality and one of the following approaches could be applied: i) using statistical analysis, several major contributors could be identified to account for most of the R value, and the other factors could simply be neglected; ii) using modeling technique and statistical analysis, a set of coefficient can be identified to give sufficient results for the list of factors being considered, even if these factors are not orthogonal; iii) orthogonalization of these factors could be applied to obtain a set of new factors, which are combinations of the original ones and therefore with no corresponding real world meanings.

Several possible contributing factors are discussed below.
a) Number of photos in which two people show up together.

One of the primary factors to affect R(A->B) (the R value from user A to B) is the number of photos they both appear in. The real world explanation is that two people are highly likely to know each other if they have ever appeared in the same photo, and they may have close relationship if they have appeared in many different photos together.
b) Number of people in each photo where two people show up together.

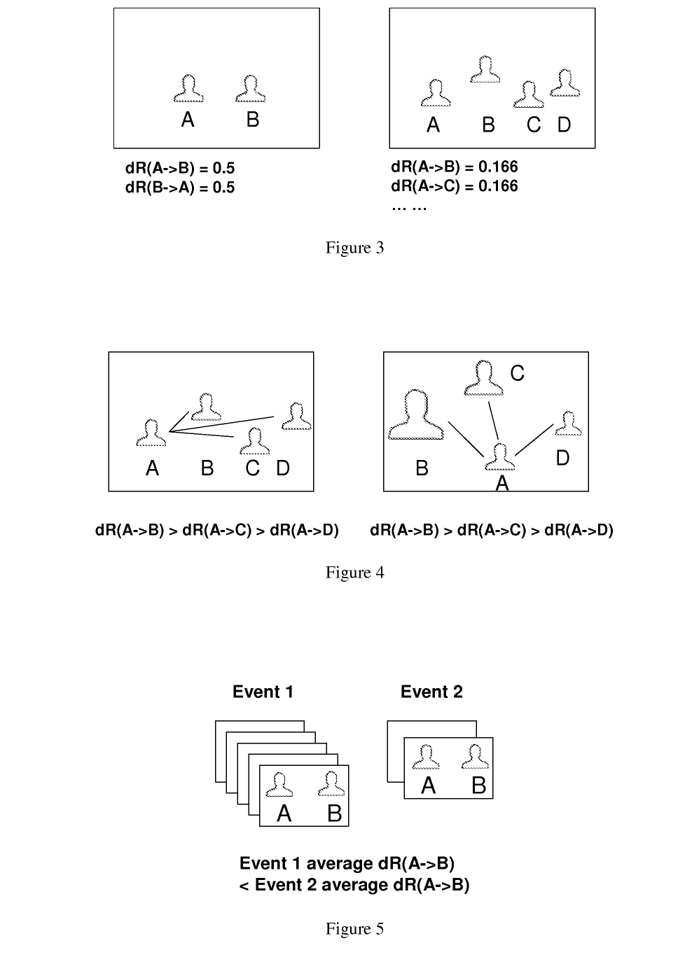

When considering a), it is reasonable to assume that if a photo only contains two people, A and B, they may have close relationship. However, if A and B both appear in a group photo with many other people, the chance that they have close relationship is much lower. As shown in FIG. 3, in one embodiment of the algorithm, with the primary level of proximity, we can use 1/Cₙ² (or 2!*(n−2)!/n!) to represent the contribution of a photo in computing relationships between pairs of people in this photo, where n is the number of total people in this photo. If there are only two people in the photo, dR for each pair-wise relationship is ½, and if there are four people, dR for each pair-wise relationship is ⅙.
c) Positions and sizes of the two faces of the two people, and distance between these two faces.

Positions, sizes and their relative positions of multiple faces on a photo also contribute in different ways in computing relationships for pairs of people in this photo (see FIG. 4).

Usually, people in the center area of a photo are the focus (or main subject) of the photo. Therefore, position of faces relative to the center of the photo (or upper center of the photo, which is the most likely position for a face to show up) can be used to modulate contributions related to this person.

Usually large sized faces indicate “more important” subject of the photo, especially when there are faces that are very different in size (the small face are likely far in the background). Such information can be used to modulate contributions from these people in the photo. For similar sized faces, this factor should be neglected because the differences most likely come from different sizes of faces in real world, or normal variation in size during the annotation process, rather than having the person with smaller face in the background.

Combining size of faces and inter-distance between two faces, the system can estimate real distance between these two heads in reality. For example, if two persons' heads are next to each other, distance between these two faces will be close to the sum of the radii of these two faces. If the distance between two faces is much larger than the sum of these two faces' radii, these two heads must be far from each other in reality. Naturally, if two heads are close to each other, more likely these two persons are also close in real life. It is natural to see that couples or close friends usually are close to each other in photos, because that's how they behave in real life as well.
d) Facing direction and facial expression of faces.

If two faces are facing each other and they are of similar sizes (so that one face is not in the background of the other), these two people may be talking to each other, looking at each other, or in other forms of communication. This is an indication of their real life interaction and may be considered as a factor to increase the R value between these two people. If two faces are facing away from each other, the opposite conclusion is indicated.

Facial expression information may be obtained by manual approach or by automatic pattern recognition technology. Such technology may not yet be reliable but may become reliable in some future time. One embodiment of its application is to consider whether certain facial expression (happiness, sadness, etc.) is correlated with the presence of certain people in photos.
e) Number of photos and time information for each event with photos that contain the two people.

When computing R(A->B), if A and B both appear in both event 1 and event 2, the numbers of photos with both A and B may be another factor to consider (FIG. 5).

If event 1 has more photos than event 2, most likely event 1 is either bigger, or more important than event 2. Therefore, if A and B both appear in more photos from event 1 than from event 2, event 1 should have a larger impact on the final R value than event 2 does (assuming other factors are the same). However, such a relationship shouldn't be linear. It takes effort for both A and B to participate in the same event together, even a smaller one. Therefore, the first photo should have the largest contribution, with each additional photo carrying less contribution.

Further analysis could be applied based on detailed analysis on time information of the events and the photos. Time information in photos usually tells the length of the events. If an event carries on for multiple days, it should carry more weight than an event that spans within a single day (it's not easy for people to stay together for multiple days). Time information also reflects the shooting style for the photographer. Some photographers are very frugal when taking photos and photos from them should contribute more to the final R value. Some photographers usually take lots of photos, including ones in consecutive mode, and photos from them should contribute less to the final R value.
f) When calculating the R value with regard to a specific time, the time difference between time of events and the specified time.

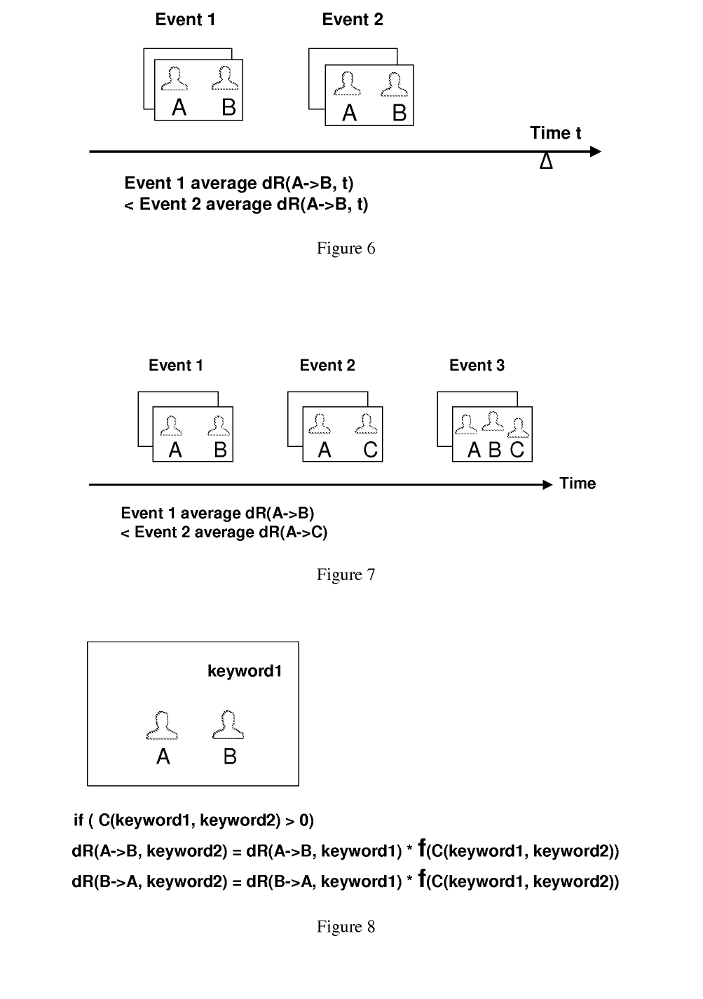

As stated before, R value is a function of time. All previous discussions are based on the assumption that a non-time specific R value is computed. When we consider the time factor, R value becomes dynamic and changes with time. When computing R(A->B, t), as shown in FIG. 6, assuming everything else is the same, contribution from event 1 is smaller than that from event 2, because event 2 is closer to time t.
g) The relativity of time: when A, B, and C appears in same photos of event 3.

However, the argument in f) above may not always be true. As shown in FIG. 7, if after events 1 and 2, A, B, and C all appear in event 3, the effect of event 1 and event 2 on the value of R(A->B) and R(A->C) at the time of event 3 may vary depending on other considerations. Usually event 2's contribution to R(A->C) is larger than event 1's contribution to R(A->B), assuming all other factors are the same. This is because event 2 is closer in time to event 3 than event 1. However, when an event 1 that happened a long time ago is considered, the conclusion could be the opposite. If someone a user met recently appeared in another photo with the same user ten years ago, they may have really close connection. Whether the contribution should be more or less can be determined by statistical modeling approaches.
h) When locations are considered.

As stated before, R value is a function of location. All previous discussions are based on the assumption that a non-location specific R value is computed. When we consider the locations, R value becomes dynamic and changes with locations.

If location 1 is correlated with location2 (geographically related such as Universal Studio and Disneyland of Los Angeles, or non-geographically but property related such as the Disneyland in Los Angeles and Orlando.) with a correlation factor C(location1, location2), dR(A->B, location2) is modulated by a function of this correlation factor as shown in formula (2):

dR(A->B, location2)=dR(A->B, location1)*f(C(location1, location2)) (2)

where f is a function of C(location1, location2).
i) When keywords are considered.

As stated before, R value is a function of keywords. All previous discussions are based on the assumption that a non-keyword specific R value is computed. When the keyword factor is considered, R value becomes dynamic and changes with keywords.

As shown in FIG. 8, if keyword1 is used to annotate a photo, this photo's contribution to R(A->B, keyword1) can be computed similarly as discussed above in a)-g). If keyword1 is correlated with keyword2 with a correlation factor C(keyword1, keyword2), dR(A->B, keyword2) is modulated by a function of this correlation factor as shown in formula (3):

dR(A->B, keyword2)=dR(A->B, keyword1)*f(C(keyword1, keyword2)) (3)

where f is a function of C(keyword1, keyword2).
j) When user behavior information is considered.

When the users use a photo sharing system, user behavior information collected by the photo sharing system can be applied to adjust R values between specified people. For example,

R(A->B) may be adjusted by the following factors:
i) How many times A viewed photos that contain B relative to other contacts;
ii) How many times A downloaded photos that contain B relative to other contacts;
iii) How many times A applied rating to photos that contain B relative to other contacts;
iv) How many times A commented or added description to photos that contain B relative to other contacts;
v) How many times A viewed photos shared from B relative to those from other contacts;
vi) How many times A viewed, used, recommended contents or services that are either from B or based on photos that contain B relative to those from other contacts.

### 3) Algorithm to Compute Popularity

Here we use P(A) to represent popularity of user A among multiple users and P(A) is a non-negative real number. P(A) is also a function of time, location and keywords. Similar to relationship, we use P(A, t), P(A, g), P(A, keyword), P(A, t, g), P(A, t, keyword), P(A, g, keyword), and P(A, t, g, keyword) to represent different P values of A with the consideration of time, location, keywords, or combinations of them. We also use dP(A) [photo] to represent the incremental (delta) contribution towards the final P(A) from a specific photo.

When the system analyzes popularity of user A among a group of people (in this example only A, B, C, D for simplicity), all photos that include user A, B, C, D are identified from the system (in this example only 4 photos are identified for simplicity).

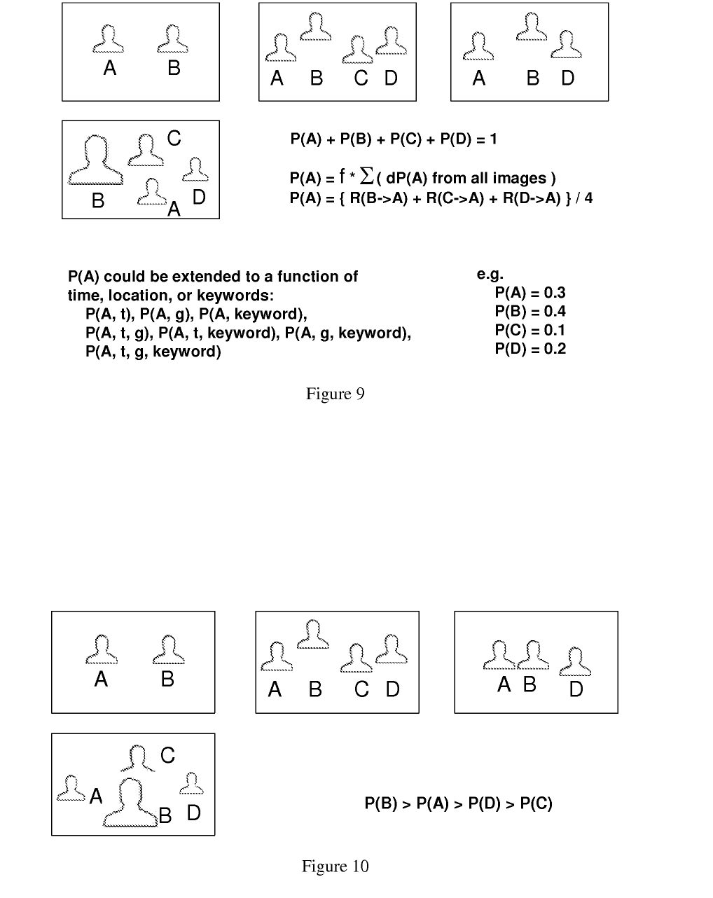

Popularities of specific users are relative values. For simplicity, they are normalized so that P values for the group of people based on which the P values are computed add up to unity. A normalization factor (f as shown in FIG. 9) is needed. As shown in FIG. 9, in one embodiment of the algorithm, P(A) can be computed by summation of dP(A) from all photos. In one embodiment of the algorithm, P(A) can also be computed by the summation of R(X->A), where X are other people in the group of people considered, normalized with a normalization factor (4 in this example, being the total number of people). As shown in FIG. 9, the following P values are computed from information in these four photos: P(A)=0.3; P(B)=0.4; P(C)=0.1; P(D)=0.2. In a simple situation like this, it is not hard to reach similar conclusion by noticing that A and B both show up in all 4 photos (although B takes more central positions and shows up with larger faces on average), while C shows up in 2, and D in 3. To compute P values in real implementation of the system, multiple additional factors need to be considered (they are described in detail below).

One way to estimate P(A), relative popularity of person A among multiple people, is by using the following formula:

P(A)=f Σ(m₁*c₁+m₂*c₂+ . . . +mₙ*cₙ) (4)

In formula (4), Σ is used to represent that contributions from all photos are added together to get the final P value. c₁, c₂, . . . , cₙ are contributions from n different resources (each resource corresponding to a property, such as relative size of the person's face in a photo) for each single photo, m₁, m₂, . . . , mₙ are modulation factors for the n different resources for each single photo, and f is a coefficient (which is constant) for normalization purpose. Contribution from each resource (or property) could be the plain numerical value of this resource (or property). However, most likely it will take the form of some mathematical derivation from such values (such values are usually put in logarithmic scale, but other variations or more complicated form are also possible). Contributions from some resources may also take the form of modulation factors to adjust the contributions from other factors.

P(A) can also be viewed as the sum of all R values from other people in the group to A, as illustrated with the following basic formula:

P(A)=Σ R(X->A)/n (5)

In formula (5), Σ is used to represent that R values from all other users to A are added together to get the final P value. n is the total number of people in the considered group, which serves as the normalization factor to ensure that P values for all people add up to unity.

In these formulas, simple addition is used to combine contributions from different resources and different photos. However, other forms of combination may also be possible.

The basic assumption to use this formula is that contributions from different resources (c₁, c₂, . . . , cₙ) are orthogonal; in other words, there is no correlation between these factors. However, this is usually not the case in reality and one of the following approaches could be applied: i) using statistical analysis, several major contributors could be identified to account for most of the P value, and the other factors could simply be neglected; ii) using modeling technique and statistical analysis, a set of coefficient can be identified to give sufficient answer for the list of factors being considered, even if these factors are not orthogonal; iii) orthogonalization of these factors could be applied to obtain a set of new factors, which are combinations of the original ones and therefore with no corresponding real world meanings.
a) Number of photos in which the person shows up.

One of the primary factors that affects P(A) (the P value from user A) is the number of photos A appears in. The real world explanation is that A is highly likely to be very popular if A appears in many photos. As shown in FIG. 10, P(B) and P(A) are greater than P(D), which is in turn greater than P(C), because A and B appear in all 4 photos, D in 3, and C in only 2.
b) Positions and sizes of the faces for the specified person.

Positions, sizes and relative positions to other faces on a photo also contribute in different ways in computing popularity for the specified person in this photo (see FIG. 10).

As shown in FIG. 10, usually, people in the center area of a photo are the focus (or main subject) of the photo. Therefore, position of face for the specified person relative to the center of the photo (or upper center of the photo, which is the most likely position for a face to show up) indicates different contribution from this photo to the P value of this person.

Usually large sized faces indicate “more important” subject of the photo, especially when there are faces that are very different in size (the small face are likely far in the background). Therefore, absolute size of the face of the specified person and its size relative to other people in the photo indicate different contribution from this photo to the P value of this person.

Combining size of faces and inter-distance between two faces, the system can estimate real distance between these two heads in reality. For example, if two people's heads are next to each other, distance between these two faces will be close to the sum of the radii of these two faces. If the distance between two faces is much larger than the sum of these two faces' radii, these two heads must be far from each other in reality. Naturally, if two heads are close to each other, one person is more “popular” to the other in real life comparing to similar situations where two heads are far from each other.
c) Facing direction and facial expression of faces.

If a face is faced to more often than that of others in a collection of photos, it is an indication that the owner of this face is more “popular” in real life.

Facial expression information may be obtained by manual approach or by pattern recognition technology. Such technology may not yet be reliable but may become reliable in some future time. If certain dramatic facial expression (happiness, sadness, etc.) is correlated with the presence of certain person in photos, this person may be more important to the affected people than others, thus should modify the P value of this person accordingly.
d) Number of photos and time information for each event with photos that contain the specified person.

When computing P(A), if A appears in both event 1 and event 2, the numbers of photos with A in these events may be another factor to consider.

As shown in FIG. 11, if event 1 has more photos than event 2, most likely event 1 is either bigger, or more important than event 2. Therefore, if A appears in more photos from event 1 than that from event 2, event 1 should have a larger impact on the final P value than event 2 (assuming other factors are the same). However, such a relationship shouldn't be linear because it takes effort to participate an event, even a small one. Therefore, the first photo that contains A should have the largest contribution, with each additional photo carrying less contribution.

Further analysis could be applied based on detailed analysis on time information of the events and the photos. Time information in photos usually tells the length of the events. If an event carries on for multiple days, it should carry more weight than an event that spans within a single day (it's not easy for A to be “welcomed” by other event members for multiple days). Time information also reflects the shooting style of the photographer. Some photographers are very frugal when taking photos and photos from them should contribute more to the final P value. Some photographers usually take lots of photos, including ones in consecutive mode, and photos from them should contribute less to the final P value.
e) When calculating the P value with regard to a specific time, the time difference between time of events and the specified time.

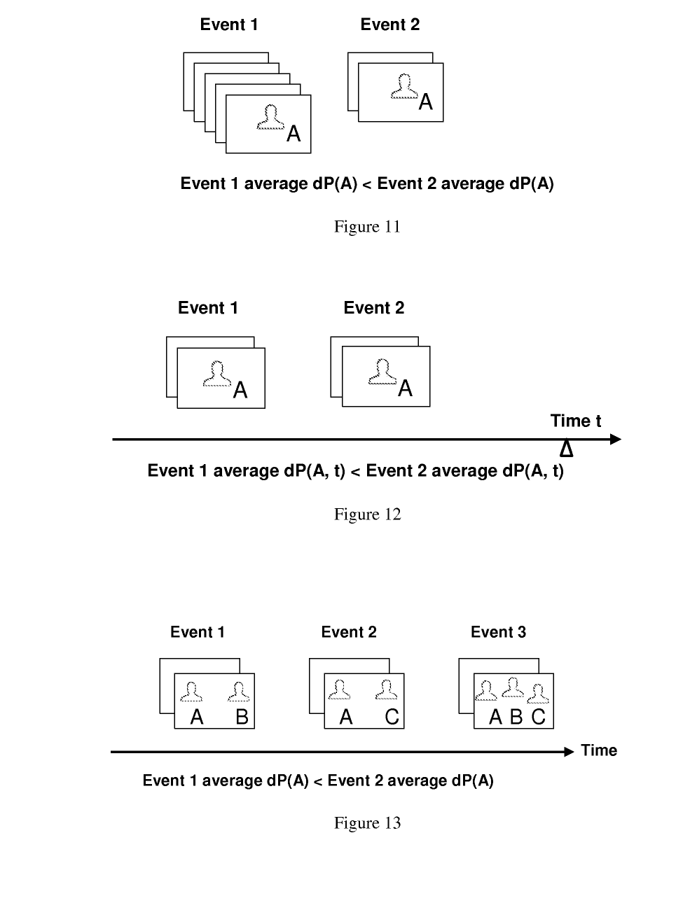

As stated before, P value is a function of time. All previous discussions are based on the assumption that a non-time specific P value is computed. When we consider the time factor, P value becomes dynamic and changes with time. When computing P(A, t), as shown in FIG. 12, assuming everything else is the same, contribution from event 1 is smaller than that from event 2, because event 2 is closer to the specified time t.
f) The relativity of time: when A, B, and C appears in same photos of event 3.

However, the argument in e) above may not always be true. As shown in FIG. 13, if after events 1 and 2, A, B, and C all appear in event 3, the effect of event 1 and event 2 on the value of P(A) at the time of event 3 may vary depending on other considerations.? Usually event 2's contribution to P(A) is larger than event 1's contribution to P(A), assuming all other factors are the same. This is because event 2 is closer in time to event 3 than event 1. However, if event 1 happened a long time ago, the conclusion could be the opposite. If someone a user met recently appeared in another photo with the user ten years ago, they may have really close connection, therefore contributing more to the P value. Whether the contribution should be more or less can be determined by statistical modeling approaches.
g) When locations are considered.

As stated before, P value is a function of locations. All previous discussions are based on the assumption that a non-location specific P value is computed. When location is considered, P value becomes dynamic and changes with locations.

If location1 is correlated with location2 (geographically related such as Universal Studio and Disneyland of Los Angeles, or non-geographically but property related such as the Disneyland in Los Angeles and Orlando.) with a correlation factor C(location1, location2), dP(A, location2) is modulated by a function of this correlation factor as shown in formula (6):

dP(A, location2)=dP(A, location1)*f((C(location1, location2)) (6)

where f is a function of C(location1, location2).
h) When keywords are considered.

As stated before, P value is a function of keywords. All previous discussions are based on the assumption that a non-keyword specific P value is computed. When keyword factor is considered, P value becomes dynamic and changes with keywords.

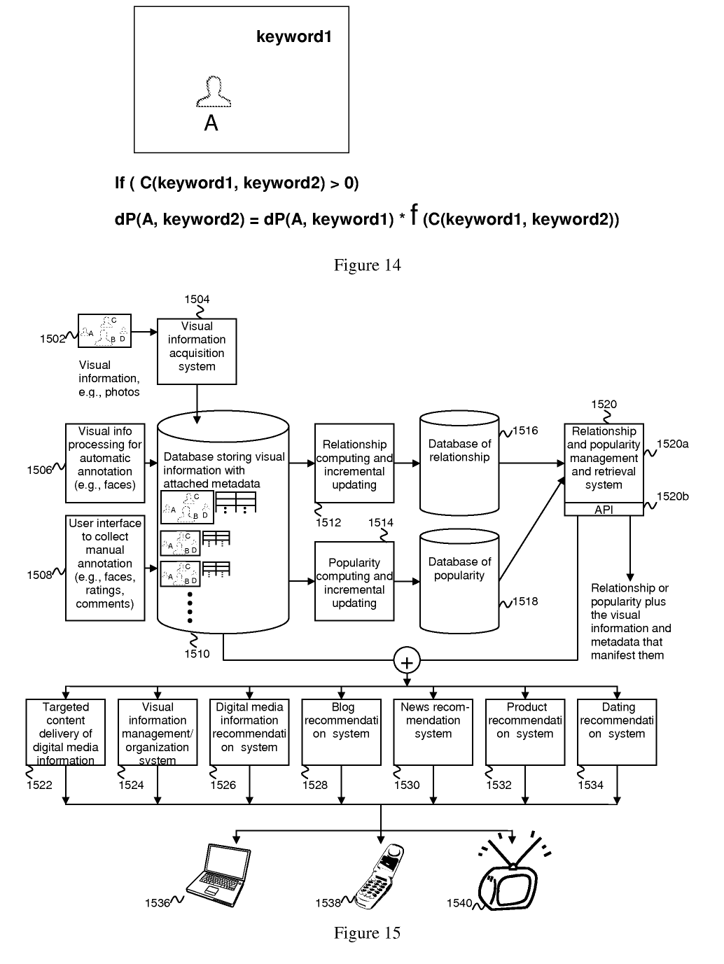

As shown in FIG. 14, if keyword1 is used to annotate a photos, this photo's contribution to P(A, keyword1) can be computed similarly as discussed above in a)-f). If keyword1 is correlated with keyword2 with a correlation factor C(keyword1, keyword2), dP(A, keyword2) is modulated by a function of this correlation factor as shown in formula (7):

dP(A, keyword2)=dP(A, keyword1)*f ((C(keyword1, keyword2)) (7)

where f is a function of C(keyword1, keyword2).
i) When user behavior information is considered.

When the users use a photo sharing system, user behavior information collected by the photo sharing system can be applied to adjust P values of specified person. For example, P(A) may be adjusted by the following factors:

i) How many times photos that contain A are viewed relative to other people;
ii) How many times photos that contain A are downloaded relative to other people;
iii) How many times photos that contain A are rated relative to other people and the average rating;
iv) How many times photos that contain A are commented or added with description relative to other people;
v) How many times photos shared from A are viewed relative to those from other people;
vi) How many times contents or services that are either from A or based on photos that contain A are viewed, used, or recommended relative to those from other people.
4) A System to Manage and Retrieve the Relationship/Popularity Information and Personal Visual Data that Relate to or Manifest such Information

In one embodiment of the present invention, a system is provided to manage and retrieve relationship information and popularity information (illustrated in FIG. 15 as blocks 1520 and 1524). This system also retrieves the personal visual data, e.g., photos and videos, which relate to or manifest such relationship and popularity information, thus creating a powerful method to navigate through large amount of personal visual data. The system provides a platform independent Application Programming Interface (API) (block 1520b in FIG. 15). With such an API, third party applications can be built on top of the system and utilize relationship information and popularity information to offer value-adding functionalities for end users.

The system is designed to be platform independent, network transparent and operating system independent. Being platform independent ensures that the system can be used on any hardware platform, i.e. computers, cell phones, home electronics, etc. Being network transparent ensures that the system can be used under any type of network transfer protocol. Being operating system independent ensures that the system can be used with any operating systems, i.e. Windows, Linux, Symbian, etc.

The system provides an interface to access and retrieve relationship information and popularity information without exposing the internal data structure and storage of the data. Some embodiments of this system are:

### For Retrieving Relationship Data:

i) Given the user ID (unique identifier for users) of two users A and B, return the relationship value of A toward B. This relationship value can be retrieved with or without the constraints of time, location, keyword, etc. When constraints are specified, they can be freely combined to limit the search results. For example, to retrieve the quantified relationship between A and B at the end of 2005 in business related activities, we can set the time constraint to be Dec. 31, 2005, and pick keywords as “business”. When the time constraint is set to be a duration instead of a time point, a series of relationship values within the specified duration will be returned.

Besides the relationship values, this interface also provides an option of returning personal visual data that manifest/support such relationship values.

ii) Given the user ID of a user A, return the top-N users that have the highest relationship values with user A, where N is a given number such as 10 or 20. This interface can also be constrained by a free combination of time, location and keywords. For example, we can combine the time and location constraints to retrieve top-10 users that have the highest relationship values with user A by the end of 2005 in the state of California.

Besides the returned users, this interface also provides an option of returning personal visual data that manifest/support such ranking.

iii) Given the user ID of a user A, return the top-N users that have the fastest increases/decreases in their relationship values with user A. Similar to the previous interface, this interface can also be constrained by a free combination of time, location and keywords.

Besides the returned users, this interface also provides an option of returning personal visual data that manifest/support such ranking.

### For Retrieving Popularity Data:

i) Given the user ID (unique identifier for users) of user A, and a specific group of users, return the popularity value of A within this group. This popularity value can be retrieved with or without the constraints of time, location, keyword, etc. When constraints are specified, they can be freely combined to limit the search results. For example, to retrieve the quantified popularity of A at the end of 2005 in business related activities within Anderson school of UCLA, we can set the group as Anderson school of UCLA, set the time constraint to be Dec. 31, 2005, and pick keywords as “business”. When the time constraint is set to be a duration instead of a time point, a series of popularity values within the specified duration will be returned.

Besides the popularity values, this interface also provides an option of returning personal visual data that manifest/support such popularity values.

ii) Given a specific group of users, return the top-N users that have the highest popularity values within this group, where N is a given number such as 10 or 20. This interface can also be constrained by a free combination of time, location and keywords. For example, we can combine the time and location constraints to retrieve top-10 users that have the highest popularity values within UCLA alumni by the end of 2005 in the state of California.

Besides the returned users, this interface also provides an option of returning personal visual data that manifest/support such ranking.

iii) Given a specific group of users, return the top-N users that have the fastest increases/decreases in their popularity values within this group. Similar to the previous interface, this interface can also be constrained by a free combination of time, location and keywords.

Besides the returned users, this interface also provides an option of returning personal visual data that manifest/support such ranking.

### 5) Applications Using Relationship Information or Popularity Information

Relationship and popularity information obtained using the system and method described above can be applied to multiple applications. Some embodiments are:
a priority list presented to the recipient to guide whose photos/videos to watch first (illustrated as blocks 1522 and 1526 in FIG. 15);
a priority list presented to the recipient to guide whose blogs to read first (block 1528);
a priority list presented to the recipient to guide which news to read (based on whether the recipient's friends have read them or other news related to them, and the relationship between the recipient and his/her friends), or which websites to visit (block 1530);
a priority list presented to the recipient to guide which products to buy (based on whether the recipient's friends have bought them or products related to them, and the relationship between the recipient and his/her friends) (block 1532);
a priority list presented to the recipient to guide which events to attend (based on whether the recipient's friends have attended them or related events, and the relationship between the recipient and his/her friends);
a priority list presented to the recipient to guide which friends to view in dating services (based on whether the recipient's friends have attended them and the relationship between the recipient and his/her friends) (block 1534); etc.
Similar applications could be extended to other devices including wireless devices as well as offline activities, such as which TV program to watch, which shops to go, which places to travel to, which hospital to visit, etc.

In general, such a high quality relationship map could be applied to any activities on the internet or offline, via any communication network, such activities include the management, delivery and acceptance of certain media or any activities associated with such information delivery. The delivery may be made via physical devices such as computers 1536, handheld mobile devices 1538, televisions 1540, etc.

It will be apparent to those skilled in the art that various modification and variations can be made in the various methods and apparatus of the present invention without departing from the spirit or scope of the invention. In particular, although various mathematical definitions and algorithms are described in this disclosure, they only represent examples of possible definitions and algorithms. Those skilled in the relevant art will recognize that other definitions and algorithms may be used to calculate relationship and popularity. For example, the relationship from A to B is described as a non-negative real number in the example given in the disclosure, but it can be made a negative value by a mathematical transform or under certain alternative algorithms. Further, it has been illustrated that the relationship from A to B or the popularity of A can be computed as a summation of the contribution from each relevant photo, and further the contribution of each photo as a summation of its various contributing factors. Such summations can be replaced with other types of mathematical formulas in order to more accurately model the dependencies between relationship/popularity and the contributing factors in a specific application. In addition, the aforementioned mathematical formulas and algorithms that apply to photos can be easily extended to apply to other types of visual information. For example, to apply them to a video, we can break the video into a sequence of photos with the metadata of these photos being highly relevant to each other, e.g., taken with high temporal and geographical adjacency, showing the same group of people, and recording the same event, etc. Thus, it is intended that the present invention cover modifications and variations that come within the scope of the appended claims and their equivalents.

What is claimed is:

1. A method for managing and processing visual information, comprising:
(a) storing a plurality of pieces of visual information and associated metadata in a visual information database, the pieces of visual information having a plurality of persons present therein;
(b) calculating a plurality of relationship values based on the metadata associated with the plurality of pieces of visual information, each relationship value representing a strength of connection from one of the plurality of persons to another one of the plurality of persons; and
(c) storing the relationship values in a relationship database.

2. The method of claim 1, wherein the pieces of visual information includes digital photos or digital videos or both, and
wherein the associated metadata is obtained through automatic or manual means.

3. The method of claim 1, wherein step (b) includes:
(b1) calculating the relationship values based on the metadata stored in the visual information database at a time point; and
(b2) incrementally updating the relationship values based on the metadata added to the visual information database after the time point.

4. The method of claim 1, wherein the metadata further includes one or more of time, geographic location, and keywords as parameters, and
wherein each relationship value is a function of one or more of the parameters.

5. The method of claim 4, wherein the metadata further includes one or more of identifications of faces of persons present in the pieces of visual information, positions of faces of persons in the piece of visual information and sizes of faces of persons in the piece of visual information, and
wherein the method further includes automatically recognizing faces of persons present in the visual information and automatically determining positions or sizes of faces of persons in the visual information.

6. The method of claim 5, wherein the metadata associated with each piece of visual information further includes one or more of: an author of the visual information, an owner of the visual information, description of an event represented by the visual information, ratings by viewers of the visual information, comments by viewers of the visual information, privacy settings associated with the visual information, modification history of the visual information, and usage and viewer-behavior statistics associated with the visual information,
wherein the usage and viewer-behavior statistics include one or more of: time and frequency at which the visual information is viewed by viewers, duration of each viewing, time and frequency at which the visual information is downloaded by viewers, time and frequency at which the visual information is described, rated or commented on by viewers, and identities of the viewers.

7. The method of claim 6, wherein in step (b), each relationship value from a first person to a second person is calculated by evaluating one or more of: a number of pieces of visual information in which the first and second persons are both present, a number of persons in each piece of visual information in which the first and second persons are both present, positions and sizes of faces of the first and second persons and their distance, facing direction of the faces of the first and second persons, facial expressions of the first and second persons, an amount of visual information and time information associated with each event in which the first and second persons are both present, time differences between times of the visual information and a specified time for which the relationship value is calculated, locations associated with the visual information, keywords associated with the visual information, and usage and viewer-behavior of the first person as a viewer with respect to visual information in which the second person is present.

8. The method of claim 1, further comprising:
(d) receiving a request identifying a person, the identified person being one of the plurality of persons;
(e) producing a response to the request based on the calculated relationship values, the response including one or more of: a relationship value between the identified person and another person, identities of a predetermined number of persons that have the highest relationship values with the identified person, and identities of a predetermined number of persons that have the fastest increases or decreases in their relationship values with the identified person.

9. The method of claim 8, further comprising:
(f) retrieving from the visual information database and delivering visual information related to the response with metadata associated with the visual information.

10. A method for managing visual information, comprising:
(a) storing a plurality of pieces of visual information and associated metadata in a visual information database, the pieces of visual information having a plurality of persons present therein;
(b) calculating a plurality of popularity values based on the metadata associated with the plurality of pieces of visual information, each popularity value representing a measure of popularity of one of the plurality of persons among other ones of the plurality of persons; and
(c) storing the popularity values in a popularity database.

11. The method of claim 10,
wherein the metadata further includes one or more of: time, geographic location, keywords, identifications of faces of persons present in the pieces of visual information, positions of faces of persons in the piece of visual information, sizes of faces of persons in the piece of visual information, an author of the visual information, an owner of the visual information, description of an event represented by the visual information, ratings by viewers of the visual information, comments by viewers of the visual information, privacy settings associated with the visual information, modification history of the visual information, and usage and viewer-behavior statistics associated with the visual information,
wherein the usage and viewer-behavior statistics include one or more of: time and frequency at which the visual information is viewed by viewers, duration of each viewing, time and frequency at which the visual information is downloaded by viewers, time and frequency at which the visual information is described, rated or commented on by viewers, and identities of the viewers, and
wherein in step (b), each popularity value of a specified person is calculated by evaluating one or more of: a number of pieces of visual information in which the person is present, positions and sizes of faces of the person in the visual information, facing direction of the faces of the person, facial expressions of the person, an amount of visual information and time information associated with each event in which the person is present, time differences between times of the visual information and a specified time for which the popularity value is calculated, locations associated with the visual information, keywords associated with the visual information, and usage and viewer-behavior of other persons as viewers with respect to visual information in which the specific person is present.

12. The method of claim 10, wherein step (b) includes:
(b1) calculating the popularity values based on the metadata stored in the visual information database at a time point; and
(b2) incrementally updating the popularity values based on the metadata added to the visual information database after the time point.

13. A system for managing visual information, comprising:
a visual information database for storing a plurality of pieces of visual information and associated metadata, the pieces of visual information having a plurality of persons present therein;
a first data procession section executing an algorithm for calculating a plurality of relationship values based on the metadata associated with the plurality of pieces of visual information, each relationship value representing a strength of connection from one of the plurality of persons to another one of the plurality of persons; and
a relationship database for storing the relationship values.

14. The system of claim 13, wherein the pieces of visual information includes digital photos or digital videos or both, and
wherein the system further comprises a second data processing section for generating at least some of the associated metadata.

15. The system of claim 13, wherein the first data processing section calculates the relationship values based on the metadata stored in the visual information database at a time point, and incrementally updates the relationship values based on the metadata added to the visual information database after the time point.

16. The system of claim 14, further comprising a user interface section for receiving additional metadata from users, the additional metadata including one or more of time, geographic location, and keywords as parameters,
wherein the first data processing section calculates the plurality of relationship values as functions of one or more of the parameters.

17. The system of claim 16, wherein the metadata generated by the second data processing section further includes identifications of faces of persons present in the pieces of visual information, positions of faces of persons in the piece of visual information and sizes of faces of persons in the piece of visual information.

18. The system of claim 17, wherein the additional metadata associated with each piece of visual information received from the users further includes one or more of: an author of the piece of visual information, an owner of the piece of visual information, description of an event represented by the piece of visual information, ratings by viewers of the piece of visual information, comments by viewers of the visual information, privacy settings associated with the piece of visual information, and modification history of the piece of visual information, and
wherein the metadata generated by the second data processing section further includes usage and viewer-behavior statistics associated with the pieces of visual information, which include one or more of: time and frequency at which the piece of visual information is viewed by viewers, duration of each viewing, time and frequency at which the piece of visual information is downloaded by viewers, time and frequency at which the piece of visual information is described, rated or commented on by viewers, and identities of the viewers.

19. The system of claim 18, wherein the first data processing section calculates each relationship value from a first person to a second person by evaluating one or more of: a number of pieces of visual information in which the first and second persons are both present, a number of persons in each piece of visual information where the first and second persons are both present, positions and sizes of faces of the first and second persons and their distance, facing direction of the faces of the first and second persons, facial expressions of the first and second persons, an amount of visual information and time information associated with each event in which the first and second persons are both present, time differences between times of the visual information and a specified time for which the relationship value is calculated, locations associated with the visual information, keywords associated with the visual information, and usage and viewer-behavior of the first person as a viewer with respect to visual information in which the second person is present.

20. The system of claim 13, further comprising:
a third data processing section for producing a response to a request from a requesting user identifying a person, the identified person being one of the plurality of persons, the response being based on the calculated relationship values, the response including one or more of: a relationship value between the identified person and another person, identities of a predetermined number of persons that have the highest relationship values with the identified person, and identities of a predetermined number of persons that have the fastest increases or decreases in their relationship values with the identified person.

21. The system of claim 20, wherein the third data processing section retrieves from the visual information database and delivers to the requesting user visual information related to the response with metadata associated with the visual information.

22. The system of claim 20, further comprising:
a fourth data processing section for producing a response to a request from a requesting user, the response being a priority list of visual information related to the requesting user or related to people that the requesting user has relationships with, a ranking in the priority list being determined based on the calculated relationship values from or to the requesting user.

23. A system for managing visual information, comprising:
a visual information database for storing a plurality of pieces of visual information and associated metadata, the pieces of visual information having a plurality of persons present therein;
a first data processing section for calculating a plurality of popularity values based on the metadata associated with the plurality of pieces of visual information, each popularity value representing a measure of popularity of one of the plurality of persons among other ones of the plurality of persons; and
a popularity database for storing the popularity values.

24. The system of claim 23,
wherein the metadata further includes one or more of: time, geographic location, keywords, identifications of faces of persons present in the pieces of visual information, positions of faces of persons in the piece of visual information, sizes of faces of persons in the piece of visual information, an author of the visual information, an owner of the visual information, description of an event represented by the visual information, ratings by viewers of the visual information, comments by viewers of the visual information, privacy settings associated with the visual information, modification history of the visual information, and usage and viewer-behavior statistics associated with the visual information,
wherein the usage and viewer-behavior statistics include one or more of: time and frequency at which the visual information is viewed by viewers, duration of each viewing, time and frequency at which the visual information is downloaded by viewers, time and frequency at which the visual information is described, rated or commented on by viewers, and identities of the viewers, and
wherein the first data processing section calculates each popularity value of a specified person by evaluating one or more of: a number of pieces of visual information in which the person is present, positions and sizes of faces of the person, facing direction of the faces of the person, facial expressions of the person, an amount of visual information and time information associated with each event in which the person is present, time differences between times of the pieces of visual information and a specified time for which the popularity value is calculated, locations associated with the visual information, keywords associated with the visual information, and usage and viewer-behavior of other persons as viewers with respect to pieces of visual information in which the specific person is present.

25. The system of claim 23, wherein the first data processing section calculates the popularity values based on the metadata stored in the visual information database at a time point, and incrementally updates the popularity values based on the metadata added to the visual information database after the time point.
